(19) United States
(12) Patent Application Publication
(10) Pub. No.: US 2025/0187370 A1
(43) Pub. Date: Jun. 12, 2025

(54) Hub

(71) Applicant: GLORY WHEEL ENTERPRISE CO., LTD., Taichung City (TW)

(72) Inventor: CHIEN-HAO LEE, Taichung City (TW)

(21) Appl. No.: 18/969,842

(22) Filed: Dec. 5, 2024

(30) Foreign Application Priority Data
Dec. 11, 2023 (TW) 112148133

(51) Int. Cl. B60B 27/04; B60B 27/02

(52) U.S. Cl. CPC B60B 27/047; B60B 27/023

(57) ABSTRACT

A hub installed on a bicycle wheel includes a hub body, a ratchet wheel assembly dispositions in the hub body and a ratchet seat engaged with the ratchet wheel assembly. The ratchet wheel assembly allows the hub body and the ratchet seat to achieve a synchronous rotation state or an asynchronous rotation state. When the hub body and the ratchet seat are in the asynchronous rotation state, the outer ratchet wheel is axially moved relative to the ratchet seat.

### FIELD OF INVENTION

The disclosure is related to a bicycle device, especially to a hub.

### BACKGROUND OF THE INVENTION

A conventional bicycle uses an installation of a conventional hub on the axle of a bicycle wheel to facilitate rotation of the bicycle wheel. When a user pedals, the conventional hub rotates to make the bicycle wheel rotate synchronously with the hub to propel the bicycle forward.

The conventional hub includes a ratchet wheel set with unidirectional engagement. When the user stops pedaling, the ratchet wheel set removes a linkage between the conventional hub and the pedals of the bicycle to allow the bicycle wheel to remain rotating. However, the ratchet wheel set with unidirectional engagement is prone to wear under a long-term use and results in reducing the service life of the ratchet wheel set.

### SUMMARY OF THE INVENTION

Therefore, an object of the present invention is to provide a hub to resolved the problem previously mentioned.

According to the present invention, the hub includes a hub body, a ratchet wheel assembly disposed in the hub body and a ratchet seat engaged with the ratchet wheel assembly. The ratchet wheel assembly includes an outer ratchet wheel and an inner ratchet wheel. The outer ratchet wheel has an annular tooth surface positioned on an end face of the outer ratchet wheel and multiple outer ring teeth positioned on a peripheral face of the outer ratchet wheel. The inner ratchet wheel has an annular tooth recess located on an end face of the inner ratchet wheel and multiple inner ratchet teeth positioned on a peripheral face of the inner ratchet wheel. The ratchet seat has multiple inner ring teeth engaged with the outer ring teeth and dispositioned on an inside face of the ratchet seat and corresponding to the outer ring teeth. A tooth-face length of the inner ring teeth is shorter than a tooth-face length of the outer ring teeth.

The ratchet wheel assembly is coaxially and movably disposed in the hub body, such that the annular tooth surface of the outer ratchet wheel and the annular tooth recess of the inner ratchet wheel are engaged with each other to allow the hub body and the ratchet seat to achieve a synchronous rotation state or an asynchronous rotation state; when the hub body and the ratchet seat are in the asynchronous rotation state, the outer ratchet wheel is axially moved relative to the ratchet seat.

The inner ring teeth are recessed to form an inner ring recess being adjacent to an end of the ratchet seat.

The inner ring teeth mesh with the outer ring teeth.

A difference between the tooth-face length of the inner ring teeth and the tooth-face length of the outer ring teeth is not smaller than a movement distance of axial displacement of the outer ratchet wheel.

The inner ring teeth and the outer ring teeth are made from different materials respectively, and a material hardness of the inner ring teeth is less than a material hardness of the outer ring teeth.

At least a portion of the outer ratchet wheel near an end of the ratchet seat corresponds to an inner ring recess of the inner ring teeth.

Each outer ring tooth further includes a chamfering face facing toward the ratchet seat, and the chamfering face is positioned at an edge of the outer ring tooth and is inclined toward the ratchet seat.

The movement distance of axial displacement of the outer ratchet wheel corresponds to an axial length of a blocking face of the annular tooth surface.

### BRIEF DESCRIPTION OF THE DRAWINGS

FIG. 1 is a perspective view illustrating a preferred embodiment of a hub according to the present invention;

FIG. 2 is an exploded perspective view illustrating the preferred embodiment of the hub;

FIG. 3 is a first enlarged exploded perspective view illustrating the preferred embodiment of the hub;

FIG. 4 is a cross-sectional side view illustrating the preferred embodiment of the hub;

FIG. 5A is a second enlarged partial side view illustrating the preferred embodiment of the hub; and

FIG. 5B is a third enlarged partial side view illustrating the preferred embodiment of the hub.

### DETAILED DESCRIPTION OF THE PREFERRED EMBODIMENTS

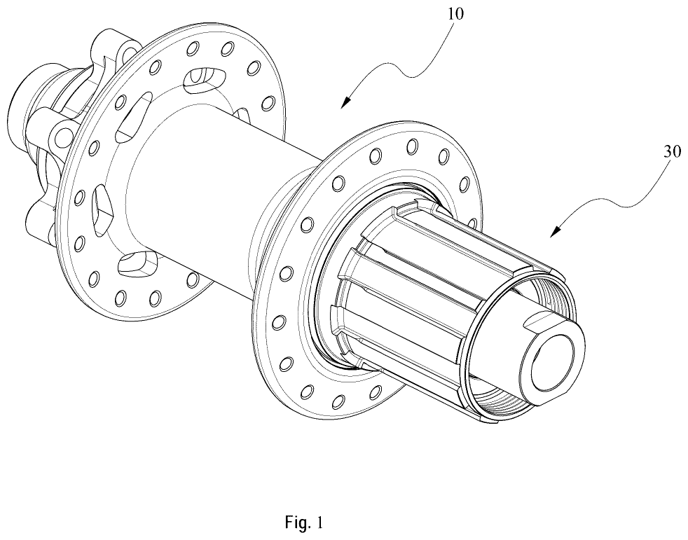

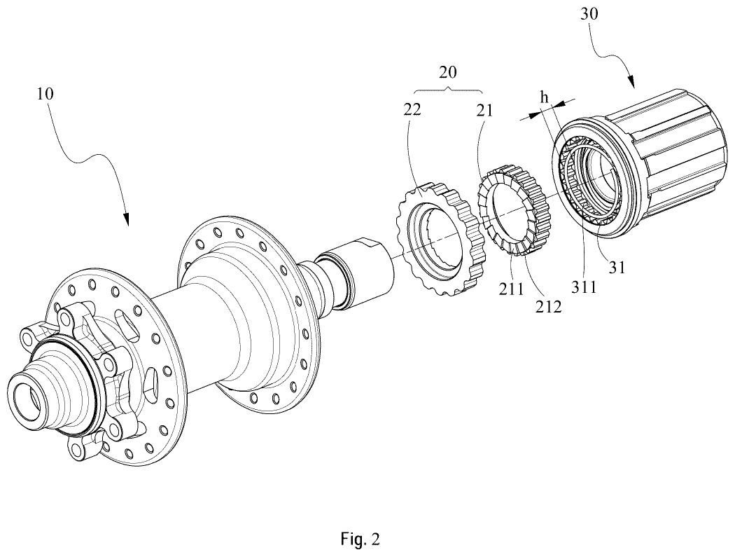

Referring to FIGS. 1 to 3, a preferred embodiment of a hub is disclosed. The hub includes a hub body 10, a ratchet wheel assembly 20 disposed in the hub body 10 and a ratchet seat 30 engaged with the ratchet wheel assembly 20. The hub body 10 is configured to be installed on an axle of a bicycle wheel of a bicycle and to be coupled to the bicycle wheel via a peripheral surface of the hub body 10. The ratchet seat 30 is engaged with and mounted around a peripheral surface of the ratchet wheel assembly 20 and is assembled with a freewheel. When a user pedals, a chain engaged with the freewheel rotates together with pedals of the bicycle, thereby the pedals drive the freewheel, the ratchet seat 30, the hub body 10, and the bicycle wheel to rotate synchronously to allow the bicycle to move forward.

The ratchet wheel assembly 20 is disposed coaxially and movably in the hub body 10. The ratchet wheel assembly 20 includes an outer ratchet wheel 21 and an inner ratchet wheel 22. The outer ratchet wheel 21 and the inner ratchet wheel 22 are unidirectionally engaged with each other.

In this embodiment, the outer ratchet wheel 21 is annular and includes an annular tooth surface 211 positioned on an end face of the outer ratchet wheel 21 and multiple outer ring teeth 212 located on a peripheral face of the outer ratchet wheel 21. The outer ratchet wheel 21 is engaged with the ratchet seat 30 via the outer ring teeth 212 to allow the annular tooth surface 211 to face to the inner ratchet wheel 22.

The inner ratchet wheel 22 is annular and includes an annular tooth recess 221 positioned on an end face of the inner ratchet wheel 22 and multiple inner ratchet teeth 222 located on a peripheral face of the inner ratchet wheel 22. The inner ratchet wheel 22 is engaged with the hub body 10 via the inner ratchet teeth 222 and is engaged with the annular tooth surface 211 of the outer ratchet wheel 21 via the annular tooth recess 221.

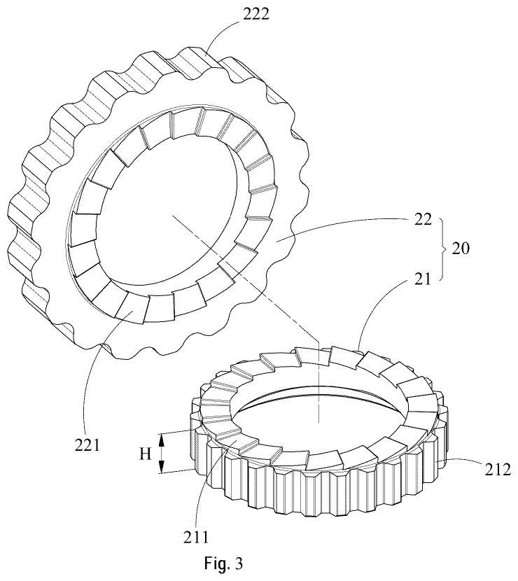

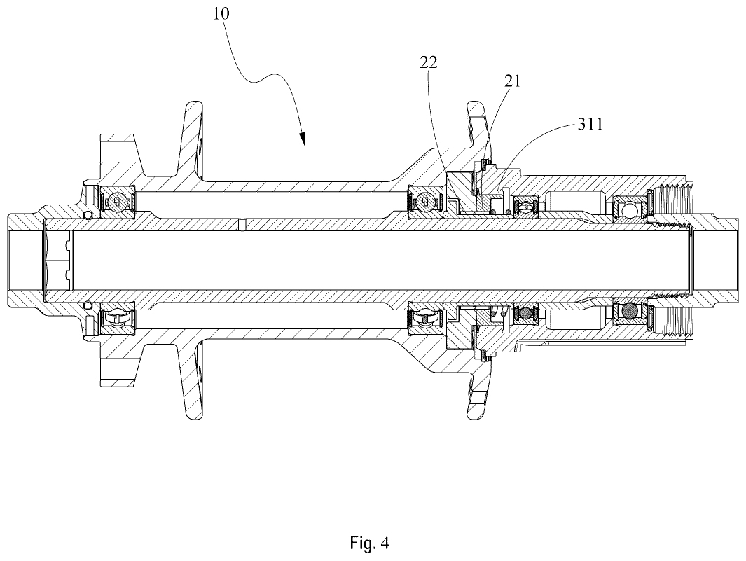

Referring to FIG. 3 and FIG. 4, the annular tooth surface 211 corresponds complementarily to the annular tooth recess 221 and is unidirectionally engaged with the annular tooth recess 221. The unidirectional engagement refers to a selective engagement between the annular tooth surface 211 and the annular tooth recess 221 based on a relative rotational direction between the outer ratchet wheel 21 and the inner ratchet wheel 22. For example, when the outer ratchet wheel 21 and the inner ratchet wheel 211 are rotated in the same clockwise direction about a central axis of the hub, the outer ratchet wheel 21 and the inner ratchet wheel 211 are engaged with each other. When the outer ratchet wheel 21 and the inner ratchet wheel 22 are rotated in reverse directions respectively about the central axis, the outer ratchet wheel 21 and the inner ratchet wheel 211 are disengaged from each other.

In this embodiment, the annular tooth surface 211 includes at least one ratchet tooth having an incline face and a blocking face. The blocking face is formed on the end face of the outer ratchet wheel 21 and extends parallel to a central axis of the end face. The incline face is formed on the end face and is connected to a side of the blocking face. When the annular tooth surface 211 includes multiple ratchet teeth, the inclined surfaces of the multiple ratchet teeth extend in the same direction. The blocking face of the ratchet tooth abuts the annular tooth recess 221 during rotation of the inner ratchet wheel 22 to allow the inner ratchet wheel 22 to engage with the outer ratchet wheel 21. When the inner ratchet wheel 22 is rotated in a reverse direction to make the incline face abutting the annular tooth recess 221, the inner ratchet wheel 22 is disengaged from the outer ratchet wheel 21. At this time, the outer ratchet wheel 21 does not rotate together with the inner ratchet wheel 22 and is moved axially along an extending direction of the incline face to create an interspace between the annular tooth surface 211 and the annular tooth recess 221.

The ratchet wheel assembly 20 is engaged with the hub body 10 via the inner ratchet teeth 222 of the inner ratchet wheel 22 and is engaged with the ratchet seat 30 via the outer ring teeth 212 of the outer ratchet wheel 21. Consequently, the hub body 10 and the ratchet seat 30 are rotated respectively with the inner ratchet wheel 22 and the outer ratchet wheel 21.

Additionally, the ratchet seat 30 is sleeved around a peripheral surface of the outer ratchet wheel 21. The ratchet seat 30 includes multiple inner ring teeth 31 formed on an inner surface of the ratchet seat 30 and corresponding to a position of the outer ring teeth 212. The inner ring teeth 31 are engaged with the outer ring teeth 212. When the outer ring teeth 212 are rotated, the inner ring teeth 31 can be rotated synchronously with the outer ring teeth 212.

A tooth-face length h of the inner ring teeth 31 is smaller than a tooth-face length H of the outer ring teeth 212, and the inner ring teeth 31 are engaged with the outer ring teeth 212.

When the outer ratchet wheel 21 does not rotate together with the inner ratchet wheel 22 and is disengaged from the inner ratchet wheel 22, the outer ring teeth 212 of the outer ratchet wheel 21 are moved axially relative to the inner ring teeth 31 of the ratchet seat 30. The tooth-face length h of the inner ring teeth 31 is smaller than the tooth-face length H of the outer ring teeth 212.

Additionally, each outer ring tooth 212 further includes a chamfering face facing toward the ratchet seat 30, and the chamfering face is positioned at an outer edge of the outer ring tooth 212 and is inclined toward the ratchet seat 30. A design of the chamfering face can reduce a contact area between the outer ring teeth 212 and the inner ring teeth 31 during engagement to prevent the edges of the outer ring teeth 212 from wearing or scratching the inner ring teeth 31.

Thus, the ratchet wheel assembly 20 can make use of a selective engagement between the outer ratchet wheel 21 and the inner ratchet wheel 22 to allow the hub body 10 and the ratchet seat 30 to achieve a synchronous rotation state or an asynchronous rotation state optionally. The synchronous and asynchronous rotation states described above will be further explained subsequently.

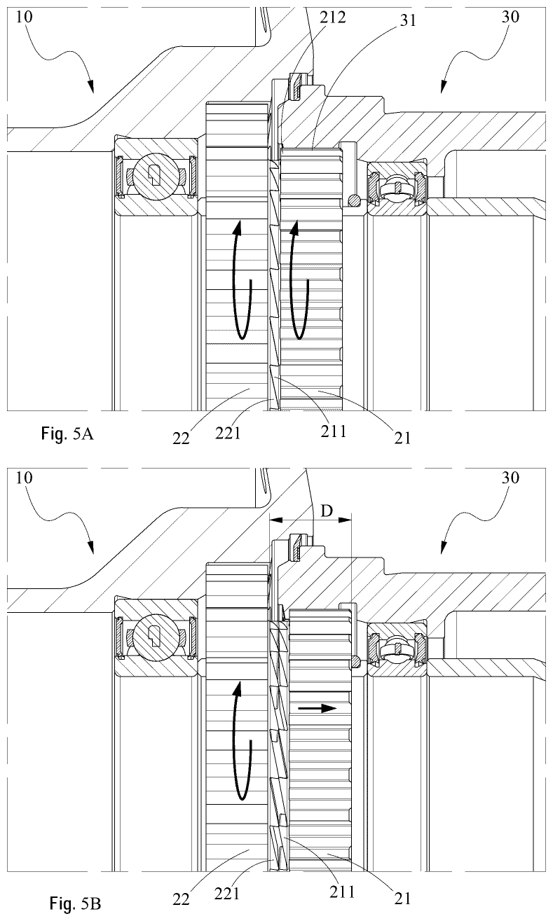

Referring to FIG. 5A, when the user pedals, a chain mounted around a freewheel of the bicycle is rotated with the pedals, thereby the ratchet seat 30 and the hub body 10 are driven to rotate. At this time, the outer ratchet wheel 21 is driven by the ratchet seat 30, and the multiple incline faces formed on the annular tooth surface 211 are engaged with multiple ratchet teeth formed in the annular tooth recess 221. A driving force is generated by pedaling to make the inner ratchet wheel 22 rotate synchronously with the outer ratchet wheel 21. At this point, the bicycle is moved forward in the same direction as a rotational direction of the outer ratchet wheel 21, thereby the synchronous rotation state is formed.

Referring to FIG. 5B, when the user stops pedaling, the ratchet seat 30 and the outer ratchet wheel 21 also stop rotating, a rear wheel of the bicycle continues to rotate due to the driving force generated during pedaling, thereby the hub body 10 and the inner ratchet wheel 22 continue to rotate. As the inner ratchet wheel 22 continues to rotate, the annular tooth recess 221 abuts against the multiple incline faces and then slides along to the next incline face of the annular tooth surface 211 in a rotational direction of the rear wheel of the bicycle. At this time, the inner ratchet wheel 22 is rotated in the same direction as the bicycle's movement, and the outer ratchet wheel 21 stops rotating forward, thereby the asynchronous rotation state is formed. In the asynchronous rotation state, the bicycle continues moving forward even when the user stops pedaling.

Furthermore, the ratchet seat 30 further includes a spring applying a biasing force to the outer ratchet wheel 21 toward the inner ratchet wheel 22. When the annular tooth surface 211 includes multiple ratchet teeth and the outer ratchet wheel 21 is moved axially toward the ratchet seat 30, the spring is compressed and subsequently resets to apply a force to push the outer ratchet wheel 21 back toward the inner ratchet wheel 22. As a result, one of the ratchet teeth corresponds to a next one of the annular tooth recess 221, thereby the outer ratchet wheel 21 can exhibit a reciprocating motion.

A movement distance D of axial displacement of the outer ratchet wheel 21 corresponds to an axial length of the blocking face of the annular tooth surface 211.

The difference between the tooth-face length h of the inner ring teeth 31 and the tooth-face length H of the outer ring teeth 212 is not smaller than the movement distance D of the outer ratchet wheel 21.

Additionally, the present invention provides a second embodiment of the hub. In the second embodiment, the inner ring teeth 31 are recessed to form an inner ring recess 311 being adjacent to an end of the ratchet seat 30. A surface depth of the inner ring recess 311 is shallower than a bottom depth of the outer ring teeth 212, thereby damage to an inside face of the inner ring teeth 31 can be prevented during the reciprocating motion of the outer ring teeth 212. During the reciprocating motion of the outer ring teeth 212, the outer ring teeth 212 are moved axially toward the inner ring recess 311, such that at least a portion of the outer ring teeth 212 is positioned in the inner ring recess 311.

Notably, because a tooth-face axial length of the inner ring teeth 31 is shorter than a tooth-face axial length of the outer ring teeth 212, and the inner ring teeth 31 mesh with the outer ring teeth 212, this configuration prevents an edge of the outer ring teeth 212 from causing scratches or wear on the inner ring teeth 31 during the movement distance D experienced in the reciprocating motion of the outer ring teeth 212 relative to the inner ring teeth 31. Consequently, consumption and damage to the inner ring teeth 31 are reduced. At the same time, a design of the tooth-face axial length of the inner ring teeth 31 prevents margin tolerances between the inner ring teeth 31 and the outer ring teeth 212 during manufacturing process, thereby wear on the inner ring teeth 31 is reduced.

Furthermore, the inner ring teeth 31 and the outer ring teeth 212 are made of different materials respectively, and a material hardness of the inner ring teeth 31 is less than a material hardness of the outer ring teeth 212. For example, when the material of the outer ring teeth 212 is iron or steel, the material of the inner ring teeth 313 can be aluminum or other materials softer than iron and steel. A material selection of the inner ring teeth 31 and the outer ring teeth 212 effectively reduces wear caused by the reciprocating motion of the outer ring teeth 212 and prolongs the service life of both the outer ring teeth 212 and the inner ring teeth 31. Additionally, using lightweight materials such as aluminum for the inner ring teeth 31 can reduce the weight of the hub and achieve a weight reduction.

What is claimed is:

1. A hub comprising:
a hub body;
a ratchet wheel assembly disposed in the hub body and comprising:
an outer ratchet wheel including an annular tooth surface positioned on an end face of the outer ratchet wheel and multiple ring teeth positioned on a peripheral face of the outer ratchet wheel,
an inner ratchet wheel including an annular tooth recess located on an end face of the inner ratchet wheel and multiple inner ratchet teeth positioned on a peripheral face of the inner ratchet wheel; and
a ratchet seat engaged with the ratchet wheel assembly and comprising:
multiple inner ring teeth engaged with the outer ring teeth and dispositioned on an inside face of the ratchet seat and corresponding to the outer ring teeth;
wherein, a tooth-face length of the inner ring teeth is shorter than a tooth-face length of the outer ring teeth; and,
wherein, the ratchet wheel assembly is coaxially and movably disposed in the hub body, the annular tooth surface of the outer ratchet wheel and the annular tooth recess of the inner ratchet wheel are engaged with each other to allow the hub body and the ratchet seat to achieve a synchronous rotation state or an asynchronous rotation state; when the hub body and the ratchet seat are in the asynchronous rotation state, the outer ratchet wheel is axially moved relative to the ratchet seat.

2. The hub as claimed in claim 1, wherein the inner ring teeth are recessed to form an inner ring recess being adjacent to an end of the ratchet seat.

3. The hub as claimed in claim 1, wherein the inner ring teeth mesh with the outer ring teeth.

4. The hub as claimed in claim 2, wherein the inner ring teeth mesh with the outer ring teeth.

5. The hub as claimed in claim 3, wherein a difference between the tooth-face length of the inner ring teeth and the tooth-face length of the outer ring teeth is not smaller than a movement distance of axial displacement of the outer ratchet wheel.

6. The hub as claimed in claim 4, wherein a difference between the tooth-face length of the inner ring teeth and the tooth-face length of the outer ring teeth is not smaller than a movement distance of axial displacement of the outer ratchet wheel.

7. The hub as claimed in claim 5, wherein the movement distance of axial displacement of the outer ratchet wheel corresponds to an axial length of a blocking face of the annular tooth surface.

8. The hub as claimed in claim 6, wherein the movement distance of axial displacement of the outer ratchet wheel corresponds to an axial length of a blocking face of the annular tooth surface.

9. The hub as claimed in claim 7, wherein the inner ring teeth and the outer ring teeth are made of different materials respectively, and a material hardness of the inner ring teeth is less than a material hardness of the outer ring teeth.

10. The hub as claimed in claim 8, wherein the inner ring teeth and the outer ring teeth are made of different materials respectively, and a material hardness of the inner ring teeth is less than a material hardness of the outer ring teeth.

11. The hub as claimed in claim 1, wherein at least a portion of the outer ratchet wheel near an end of the ratchet seat corresponds to an inner ring recess of the inner ring teeth.

12. The hub as claimed in claim 2, wherein at least a portion of the outer ratchet wheel near the end of the ratchet seat corresponds to the inner ring recess.

13. The hub as claimed in claim 11, wherein each outer ring tooth further includes a chamfering face facing toward the ratchet seat, and the chamfering face is positioned at an edge of the outer ring tooth and is inclined toward the ratchet seat.

14. The hub as claimed in claim 12, wherein each outer ring tooth further includes a chamfering face facing toward the ratchet seat, and the chamfering face is positioned at an edge of the outer ring tooth and is inclined toward the ratchet seat.
